(19) United States
(12) Patent Application Publication
(10) Pub. No.: US 2025/0058849 A1
(43) Pub. Date: Feb. 20, 2025

(54) PEDAL-ASSISTED BICYCLE AND METHOD FOR CONTROLLING A PEDAL-ASSISTED BICYCLE

(71) Applicant: ZEHUS S.p.A., Milano (IT)

(72) Inventors: Giovanni ALLI, Milano (IT); Davide FORTE, Milano (IT); Pasquale FORTE, Milano (IT); Paolo LISANTI, Milano (IT)

(21) Appl. No.: 18/723,238

(22) PCT Filed: Dec. 20, 2022
(86) PCT No.: PCT/IB2022/062524

§ 371 Date: Jun. 21, 2024

(30) Foreign Application Priority Data
Dec. 23, 2021 (IT) 102021000032525

(51) Int. Cl. B62M 6/45; B62J 45/411; B62J 45/412; B62M 6/90

(52) U.S. Cl. CPC B62M 6/45; B62J 45/411; B62J 45/412; B62M 6/90

(57) ABSTRACT

A pedal-assisted bicycle includes a frame, a traction system with a battery, a central motor, a hub motor and a control unit. The central motor is directly connected to the pedal assembly to provide torque to the pedal assembly and is powered by the battery, while the hub motor is arranged at the hub and is powered by the battery. The control unit receives first input signals of an operating condition selectively variable between a servo operating condition and a charging operating condition and to detect the operating condition as a function of the first input signals and, in the servo operating condition, to emit a driving signal to drive the hub motor and the central motor following a maximum efficiency curve obtained from an envelope of the efficiency curves of the hub motor and the electric motor as a function of the linear speed (V_{bike}) and the transmission ratio.

The present invention concerns a pedal-assisted bicycle and a method for controlling a pedal-assisted bicycle.

In recent years, parallel to the growing popularity of the concepts of sustainable mobility and the continuous development of increasingly high-performing e-cars, there has been an exponential growth of what are commonly known as e-bikes, i.e. bicycles equipped with an electric propulsion system capable of assisting the cyclist while pedalling.

Such bicycles have found fertile ground both in urban applications, partly replacing mopeds, and in more extreme applications, allowing the occasional enthusiast to engage in climbs along routes that, without the aid of electric propulsion, would have been beyond their reach.

The aspects on which companies in the sector have been working the most in recent years have been therefore the size of the implementation, to be minimized in order to make the system adaptable even to “traditional” frames, and the battery life, increased using an electric hub motor functioning both as an actuator and as a generator.

With reference to the latter aspect, for “mountain bike” applications the problem related to battery life is to be considered in some way subordinate, or in any case bound, to the need for an important contribution in terms of servo feature by the motor, whereas in city applications more than a real servo feature, what is necessary is to facilitate the cyclist in the most demanding stretches, which has allowed to consider the maintenance of the state of charge of the battery as primary.

Precisely in relation to these developments, the Applicant has recently developed a system capable of controlling the electric hub motor in order to maintain the state of charge of the battery around a predetermined value, without there ever being the need (nor the possibility) to recharge the same via the network.

Such a system has been described in International Patent Application No. WO2018/130982 and is expressly referred to the use of an electric hub motor.

This choice is advantageous at high speeds while, at low speeds, it is advantageous only for transmission ratios lower than 1. In fact, the choice to use an electric hub motor is not the optimal choice in terms of efficiency at low speeds and for transmission ratios greater than 1.

Aim of the present invention is therefore to provide a pedal-assisted bicycle and a method thereof for optimally controlling it under all conditions of use.

This aim is achieved by a pedal-assisted bicycle and a method for controlling a pedal-assisted bicycle having the technical characteristics of one or more of the following claims. The dependent claims, herein incorporated for reference, correspond to different embodiments of the invention.

In accordance with a first aspect, the present invention concerns a pedal-assisted bicycle comprising a frame, at least two wheels each provided with a relative hub, a pedal assembly, a transmission operatively interposed between the pedal assembly and one of the wheels. A traction system of the bicycle comprises at least a battery pack, a central electric motor, an electric device configured to operate as an electric generator and a control unit configured to drive the electric device and the central electric motor and to manage the charge level of said battery pack. The central electric motor is directly connected to the pedal assembly to provide torque to the pedal assembly itself and is operatively connected to the battery pack to be powered by the battery pack itself. The electric device is arranged at the hub of a wheel and is operatively connected to the battery pack to transfer current towards the battery pack itself. The control unit is configured to receive a plurality of first input signals representative of an operating condition of the selectively variable bicycle between a servo operating condition and a charging operating condition. The control unit is configured to receive a second input signal representative of the state of charge of the battery pack. The control unit is configured to identify the operating condition of the bicycle as a function of the first input signals and to emit, as a function of the second input signal and the identified operating condition, a driving signal structured to drive the electric device operating as an electric generator so as to increase the charge level of the battery pack.

In accordance with a first aspect, the present invention concerns a method for controlling a pedal-assisted bicycle comprising detecting one or more quantities representative of a bicycle operating condition, wherein said operating condition is selectively variable between a servo operating condition and a charging operating condition, detecting a value representative of the state of charge of the battery pack, detecting the operating condition of the bicycle, and driving the electric device according to the identified operating condition and the state of charge of the battery pack so as to increase the charging level of the battery pack.

In accordance with a further aspect, the present invention concerns a pedal-assisted bicycle comprising a frame, at least two wheels each provided with a relative hub, a pedal assembly, a transmission operatively interposed between the pedal assembly and one of the wheels and configured to vary the transmission ratio between said pedal assembly and said wheel as a function of a command imparted (directly or indirectly) by a user. A traction system of the bicycle comprises at least a battery pack, a central electric motor, an electric hub motor, a control unit configured to drive the electric hub motor and the central electric motor. The central electric motor is directly connected to the pedal assembly to provide torque to the pedal assembly itself and is operatively connected to the battery pack to be powered by the battery pack itself. The electric hub motor is arranged at the hub of a wheel and is operatively connected to the battery pack to be powered by the battery pack itself. The control unit is configured to receive a plurality of first input signals representative of an operating condition of the selectively variable bicycle between a servo operating condition and a charging operating condition. The control unit is configured to detect the operating condition of the bicycle as a function of the first input signals and, in the servo operating condition, emit a driving signal structured to drive the electric hub motor and the central electric motor by following a maximum efficiency curve obtained from an envelope of the efficiency curves of the electric hub motor and the central electric motor according to the linear speed of the bicycle and the transmission ratio of the bicycle.

In accordance with a still further aspect, the present invention concerns a method for controlling a pedal-assisted bicycle comprising detecting one or more quantities representative of an operating condition of the bicycle, wherein the operating condition is selectively variable between a servo operating condition and a charging operating condition, detecting the operating condition of the bicycle and, in the servo operating condition, detecting the transmission ratio between said pedal assembly and said at least one wheel, driving the electric hub motor and the central electric motor following a maximum efficiency curve obtained from an envelope of the efficiency curves of the electric hub motor) and the central electric motor according to the linear speed of the bicycle and the transmission ratio of the bicycle.

Advantageously, the modulation of the contribution of the two motors according to parameters detected in real time and, in particular, the transmission ratio, allows to significantly optimize the efficiency of the servo system, optimizing the performance of the system in the various work points.

These and other features, together with the related technical advantages, will become clearer from the following exemplary, and therefore non-limiting, description of a preferred, therefore non-exclusive, embodiment of a pedal-assisted bicycle and of a relative method for controlling it, as illustrated in the attached drawing tables, in which:

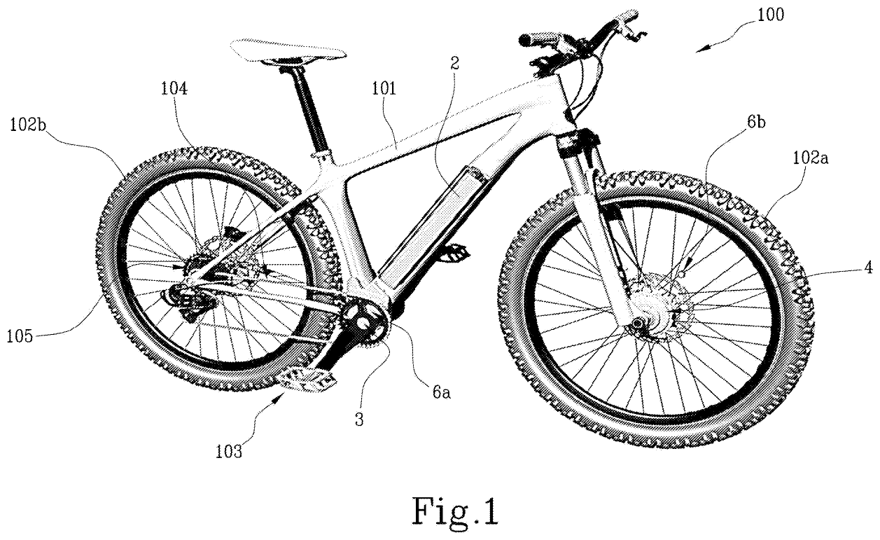

FIG. 1 schematically shows in side view a pedal-assisted bicycle;

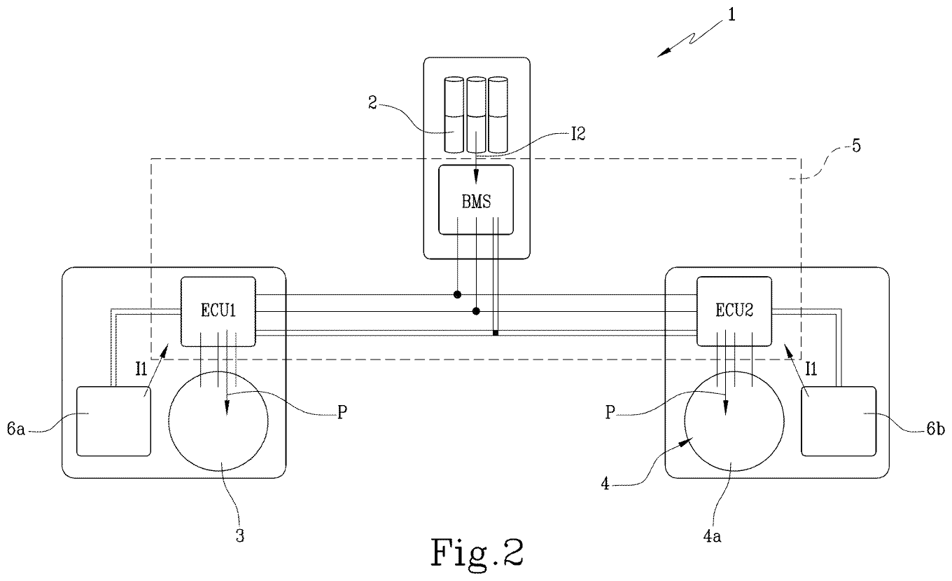

FIG. 2 shows a diagram of a traction device of the pedal-assisted bicycle of FIG. 1;

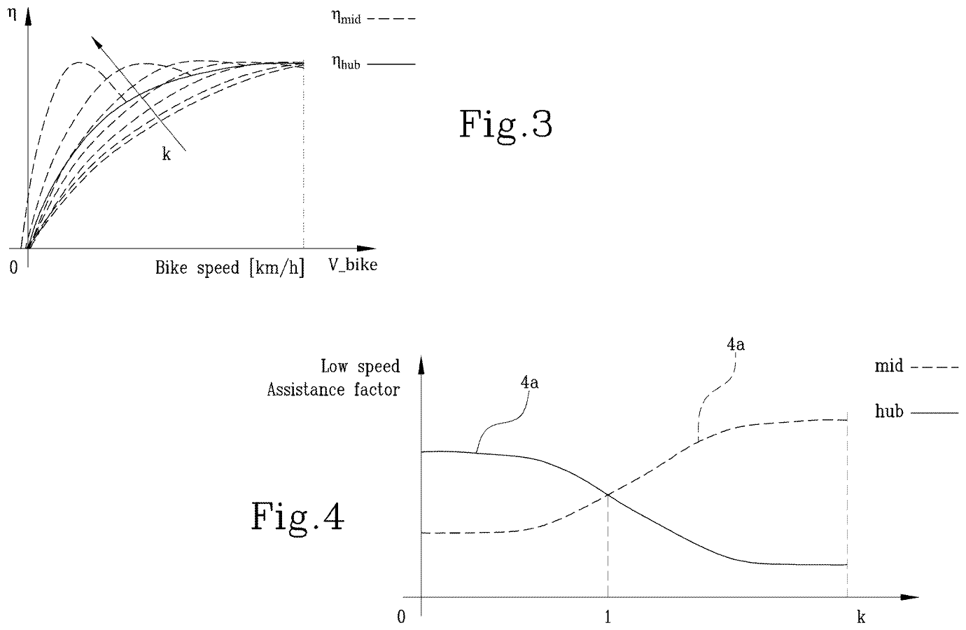

FIG. 3 shows the efficiency curves of the central electric motor and the electric hub motor according to the linear speed of the bicycle and its transmission ratio;

FIG. 4 shows a low-speed servo coefficient of the traction system as a function of the transmission ratio;

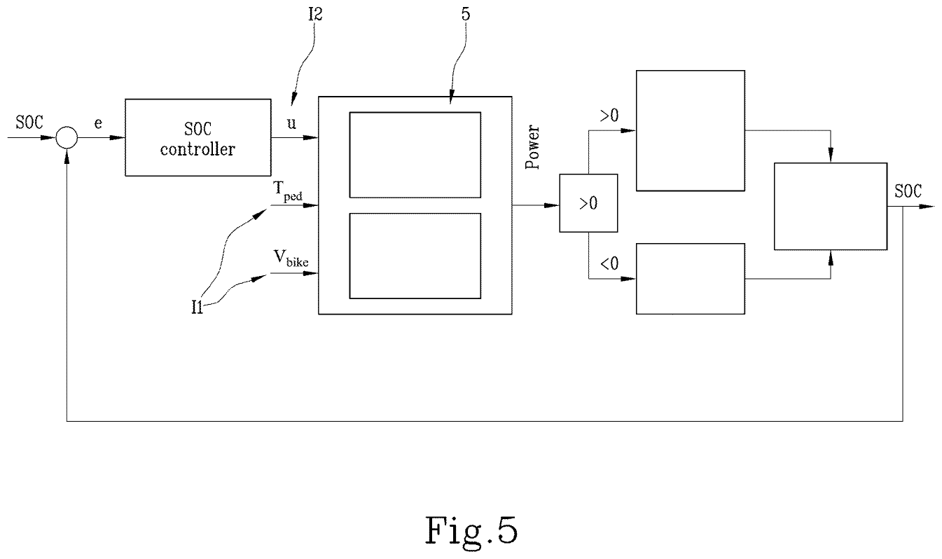

FIG. 5 shows a logical diagram of operation of the traction system of FIG. 2.

With reference to FIG. 1, 100 denotes a pedal-assisted bicycle comprising a frame 101 on which two wheels are mounted, including a front wheel 102a and a rear wheel 102b, each provided with a relative hub.

The pedal-assisted bicycle 100 further comprises a pedalling assembly 103 and a transmission system 104 (preferably with chain) for transferring the motion from the pedalling assembly 103 to one of the wheels (in particular the rear wheel 102b).

It is also provided for the presence of a free wheel mechanism 105 operatively interposed between the transmission system 104 and the rear wheel 102b, in order to allow the rotation thereof even in the absence of pedalling.

The pedal-assisted bicycle 100 comprises a traction system 1 comprising at least a battery pack 2, a central electric motor 3 and an electric device 4 operating as an electric generator.

The central electric motor 3 is directly connected to the pedal assembly 103 to provide torque to the pedal assembly itself. In addition, the central electric motor 3 is operatively connected to the battery pack 2 to be powered by the battery pack itself.

The electric device 4 is arranged at the hub of one of the wheels, preferably the front wheel 102a and is operatively connected to the battery pack 2 to transfer current towards the battery pack itself.

A control unit 5 of the traction system 1 is for example constituted by the logic unit of several modules including a battery management system (BMS or SOC controller), a first control unit ECU1 dedicated to the central electric motor 3 and a second control unit ECU2 dedicated to the electric device 4.

The control unit 5 is configured to drive the electric device 4 operating as an electric generator and the central electric motor 3. In addition, the control unit 5 is configured to manage the charge level of the battery pack 2.

In particular, the control unit 5 is configured to receive a plurality of first input signals I1 representative of an operating condition of the bicycle selectively variable between a servo operating condition and a charging operating condition.

The term “servo operating condition” means a condition in which the traction system 1 assists pedalling by providing a driving torque that is added to the torque produced by the cyclist on the pedals.

The term “charging operating condition” means a condition in which the traction system 1 does not assist pedalling and therefore does not provide any driving torque. These are for example conditions in which the bicycle is advancing downhill or at high speed greater than a predefined value, or in which an external command is explicitly activated for example by pedalling backwards or by operating a remote control or the brakes of the bicycle.

The predefined value is variable depending on the type of bicycle and national regulations, it can be for example 25 km/h, or it can reach 45 km/h for S-Pedelec in Germany, 20 mph-about 32 km/h—for Class 1 in the USA and also 28 mph for Class 3.

Preferably the first input signals I1 comprise one or more of:
a first input signal representative of the pedal speed ω_{ped},
a first input signal representative of the torque applied to the pedal assembly T_{pedal},
a first input signal representative of the linear speed of the bicycle V_{bike},
   a first input signal representative of a command of the cyclist (back pedalling, remote control, brake activation).

Preferably the traction system 1 comprises first sensor means 6a-6b operatively connected to the control unit 5 and configured to detect one or more quantities representative of the operating condition of the bicycle and to generate a respective first input signal I1. For example the first sensor means comprise a first sensor 6a and/or a second sensor 6b. The first sensor 6a is configured to detect a quantity representative of the pedal speed ω_{pedal}, and/or the torque applied to the pedal assembly T_{ped}. The second sensor 6b is configured to detect a quantity representative of the linear speed of the bicycle V_{bike}.

The control unit 5 is configured to receive a second input signal I2 representative of the state of charge (SOC) of the battery pack 2. Preferably the traction system 1 comprises second sensor means forming part of the BMS (or SOC controller) management system operatively connected to the control unit 5 and configured to detect a value representative of the state of charge SOC of the battery pack 2 and to generate the second input signal I2.

Furthermore, the control unit 5 is configured to detect the operating condition of the bicycle as a function of the first input signals I1. Such identification is for example carried out in accordance with what is described in international patent application WO2018/130982, incorporated herein by reference.

The control unit 5 is configured to emit, as a function of the second input signal I2 and the identified operating condition, a driving signal P structured to drive the electric device 4 and the central electric motor 3 so that the state of charge SOC of the battery pack 2 follows a defined reference state of charge.

Preferably the electric device 4 is an electric hub motor 4a arranged at the hub of one of the wheels, preferably of the front wheel 102a. The electric hub motor 4a can be selectively driven according to a first driving mode, in which it operates as an actuator to provide torque to the respective wheel, and according to a second driving mode, in which it operates as an electric generator to transfer current to the battery pack 2 as indicated above.

In this case, the control unit 5 is configured to emit a driving signal P structured to drive the electric device motor 4 by selecting the first driving mode when the bicycle is in the servo operating condition and by selecting the second driving mode when the bicycle is in the charging operating condition.

In the first driving mode the control unit 5 is preferably configured to emit a driving signal structured to drive the central electric motor 3 and the electric device 4 so as to combine their contributions according to the linear speed of the bicycle V_{bike} and the transmission ratio K of the bicycle. The transmission ratio K can be calculated as ω_{mid}/ω_{hub} i.e. as the ratio between the angular speed of the central electric motor 3 and the angular speed of the electric device 4.

Preferably, therefore, the control unit 5 is configured to determine, as a function of a signal, the transmission ratio k occurring between said pedal assembly and said at least one wheel.

Preferably, the central electric motor 3 and the electric device 4 are configured to respectively provide first and second torque contributions, wherein in the first driving mode of the electric device 4 the control unit 5 is configured to modulate said first and second torque contributions according to the linear speed V_{bike} of the bicycle and the transmission ratio K of the bicycle.

In use, the control of a pedal-assisted bicycle made according to at least one of the above-described embodiments provides for detecting one or more quantities representative of an operating condition of the bicycle, for example one or more of the pedal speed ω_{ped}, the torque applied to the pedal assembly T_{ped}, the linear speed of the bicycle V_{bike} and a command of the cyclist (backward pedalling, remote control, brake activation).

It is also envisaged detecting a value representative of the state of charge (SOC) of the battery pack 2 and driving the electric device 4 and the central electric motor 3 according to the identified operating condition and the state of charge of the battery pack so that the state of charge of the battery pack 2 follows a defined reference state of charge.

In particular in the case where the electric device 4 is made by means of an electric motor 4a, the control of the bicycle provides for driving the electric motor by selecting the first driving mode when the bicycle is in the servo operating condition or by selecting the second driving mode when the bicycle is in the charging operating condition (FIG. 5).

With reference to FIGS. 3 and 4, in the first driving mode the central electric motor 3 and the electric device 4 are preferably driven so as to combine their contributions according to the linear speed of the bicycle V_{bike} and of the transmission ratio K of the bicycle.

FIG. 3 illustrates a graph showing, according to the linear speed V_{bike} of the bicycle, the efficiency of the central electric motor 3 indicated as η_{mid} and the efficiency of the electric device 4 indicated as η_{hub}. The efficiency η_{hub} of the electric device 4 (i.e. of the electric motor 4a) is not affected by the transmission ratio K=ω_{mid}/ω_{hub} while the efficiency ηmid is affected by the transmission ratio K==ω_{mid}/ω_{hub} .

FIG. 3 shows that the electric device 4 is more efficient than the central electric motor 3 under two conditions: at high speeds or at low speeds if K<1. However, in the case of low speeds and K>1, the central electric motor 3 is more efficient than the electric device 4 (i.e. the electric motor 4a). It follows that, when the bicycle is in the servo operating condition and the electric device 4 is driven according to the first driving mode, it is possible to realize a combination of the two motors which is variable as a function of the transmission ratio and the linear speed. These combination possibilities are schematized in FIG. 4 in the case of low linear speeds and provide for a greater contribution of the electric device 4 if K<1 and a greater contribution of the central electric motor 3 if K>1.

With reference to FIG. 3, in the case where the electric device 4 is an electric hub motor 4a, in the servo operating condition it is possible to drive the electric hub motor 4a and the central electric motor 3 maximizing the overall efficiency of the system, in certain embodiments also independently of assessments correlated to the state of charge of the battery pack 3.

For example, such maximum efficiency can be obtained by following a maximum efficiency curve resulting from an envelope of the efficiency curves of the electric hub motor 4a and the central electric motor 3 according to the linear speed V_{bike} of the bicycle and the transmission ratio K of the bicycle.

In this case, regardless of the charging modes, one or more quantities representative of an operating condition of the bicycle are detected to identify the servo operating condition.

The control unit 5 in this case is configured to receive the plurality of first input signals I1, identify the operating condition of the bicycle as a function of the first input signals I1 and, in the servo operating condition, emit a driving signal P structured to drive the electric hub motor 4a and the central electric motor 3 following the maximum efficiency curve defined above.

1. Pedal-assisted bicycle comprising:
a frame,
at least two wheels each provided with a relative hub,
a pedal assembly,
a transmission operatively interposed between said pedal assembly and one of said wheels and configured to vary a transmission ratio between said pedal assembly and said one of said wheels as a function of a command imparted directly or indirectly by a user,
a traction system comprising:
at least one battery pack,
a central electric motor,
an electric hub motor,
a control unit configured to drive said electric hub motor and said central electric motor,
wherein said central electric motor is directly connected to the pedal assembly to provide torque to the pedal assembly itself and is operatively connected to the battery pack to be powered by the battery pack itself, wherein said electric hub motor is arranged at the hub of a wheel of said wheels and is operatively connected to the battery pack to be powered by the battery pack itself,
wherein said control unit is configured to receive a plurality of first input signals representative of an operating condition of the bicycle selectively variable between a servo operating condition and a charging operating condition,
wherein said control unit is configured to:
identify the operating condition of the bicycle as a function of the first input signals identifying said transmission ratio and
in the servo operating condition, emit a driving signal structured to drive the electric hub motor and the central electric motor following a maximum efficiency curve obtained from an envelope of the efficiency curves of the electric hub motor and the central electric motor according to the linear speed (V_{bike}) of the bicycle and the transmission ratio of the bicycle, wherein said maximum efficiency curve varies with the variation of said transmission ratio.

2. Pedal-assisted bicycle according to claim 1, wherein said first input signals comprise one or more of:
a first input signal representative of the pedal speed (ω_{ped}),
a first input signal representative of the torque applied to the pedal assembly (T_{ped}),
a first input signal representative of the linear speed of the bicycle (V_{bike}).

3. Pedal-assisted bicycle according to claim 1, wherein said traction system comprises first sensor means and second sensor means, operatively connected to the control unit, wherein said first sensor means are configured to detect one or more quantities representative of the operating condition of the bicycle and to generate a respective first input signal and wherein said second sensor means are configured to detect a value representative of the state of charge of the battery pack and to generate said second input signal.

4. Pedal-assisted bicycle according to claim 3, wherein said first sensor means (6a, 6b) comprise one or more of:
a first sensor configured to detect a quantity representative of the pedal speed (ω_{ped)} and/or torque applied to the pedal assembly (T_{ped}),
a second sensor configured to detect a quantity representative of the linear speed (V_{bike}) of the bicycle.

5. Pedal-assisted bicycle according to claim 4, wherein said control unit is configured to determine said transmission ratio according to the quantities detected by said first and by said second sensor.

6. Method for controlling a pedal-assisted bicycle comprising:
providing a pedal-assisted bicycle according to claim 1,
detecting one or more quantities representative of a bicycle operating condition, wherein said operating condition is selectively variable between a servo operating condition and a charging operating condition,
detecting or calculating a transmission ratio between said pedal assembly and said at least one wheel;
identifying the operating condition of the bicycle, and
in the servo operating condition, driving the electric hub motor and the central electric motor following a maximum efficiency curve obtained from an envelope of the efficiency curves of the electric hub motor and the central electric motor according to the linear speed (V_{bike}) of the bicycle and the transmission ratio of the bicycle.

7. Method for controlling a pedal-assisted bicycle according to claim 6, comprising detecting as quantities representative of an operating condition of the bicycle one or more of:
the pedal speed (ω_{ped})
the torque applied to the pedal assembly (T_{ped}),
the linear speed (V_{bike}) of the bicycle.
